(19) United States
(12) Patent Application Publication
(10) Pub. No.: US 2016/0138817 A1
(43) Pub. Date: May 19, 2016

(54) FLEXIBLE LIQUID DESICCANT HEAT AND MASS TRANSFER PANELS

(71) Applicant: 3M INNOVATIVE PROPERTIES COMPANY, Saint Paul, MN (US)

(72) Inventors: Thomas J. Hamlin, Vernon, CT (US); Laurence W. Bassett, Killingworth, CT (US); Rajeev Dhiman, North Haven, CT (US); Scott A. Baum, Hudson, WI (US)

(21) Appl. No.: 14/899,823

(22) PCT Filed: Jun. 25, 2014
(86) PCT No.: PCT/US14/44098

§ 371 Date: Dec. 18, 2015

Related U.S. Application Data
(60) Provisional application No. 61/839,322, filed on Jun. 25, 2013.

(51) Int. Cl. F24F 3/14; B01D 53/26

(52) U.S. Cl. CPC F24F 3/1417; B01D 53/263; B01D 53/268; F24F 2003/144; F24F 2003/1435

(57) ABSTRACT

Provided are flexible panel devices that use desiccants for heat and mass transfer processes, including but not limited to air conditioning systems, for example, liquid desiccant air conditioning (LDAC) applications wherein the liquid desiccant is contained in a panel that comprises at least one hydrophobic separation layer, which allows water vapor transfer between the air and liquid desiccant and enable dehumidification and humidification of the air. The flexible panel devices can be installed on an absorber (conditioner) side or a desorber (regenerator) side or both of a LDAC system. The devices have two flexible layers, at least one of which comprises a flexible and water vapor permeable hydrophobic separation layer, that form a desiccant flow channel and a desiccant flow distributor located therein. The two flexible layers may both be permeable hydrophobic separation layers, or they may comprise one permeable hydrophobic separation layer along with a non-porous layer.

### TECHNICAL FIELD

This disclosure relates to flexible panel devices that use desiccants for heat and mass transfer processes, including but not limited to air conditioning systems. Specifically, devices disclosed herein are particularly useful in liquid desiccant air conditioning (LDAC) applications wherein the liquid desiccant is contained in a panel that comprises one or more hydrophobic separation layers, which allow water vapor transfer between the air and liquid desiccant.

### BACKGROUND

The use of liquid desiccants for dehumidification of air has been known for well over 75 years. The application of liquid desiccants in dehumidification applied in heating, ventilating, and air conditioning (HVAC) systems has been worked on for many years. Open absorption systems for air conditioning are desirable due to their relatively simple design and driving energy at relatively low temperatures. Liquid desiccant air conditioning (LDAC) is an exemplary open absorption system.

Membrane modules have been researched and attempted for use in LDAC systems. Some module designs incorporated three fluid paths: one for desiccant, one for air, and one for coolant; and other designs incorporate two fluid paths: one for desiccant and one for air. Certain designs have provided benefits on the performance of the absorber side of the system but not on the desorber side, and overall commercial success of liquid desiccant air conditioning (LDAC) systems has been extremely limited.

### SUMMARY

Provided are heat and mass transfer panels, heat and mass transfer modules, and methods of making and using the same.

Robust hydrophobic separation layers along with panel and separation layer-based module designs which can be produced cost effectively are still needed to enable the mass production of cost effective LDAC systems. Separation-layer modules that can be produced from modular components (i.e. panels) that can be tested independently during manufacture and then subsequently assembled into modules would be extremely useful. Panel and module designs that can be produced in continuous or semi-continuous production systems at high volume are needed. Separation layers, for example, membranes, used in these modules need to maintain their mechanical robustness and hydrophobicity for long periods of time in harsh outdoor environments. There is a need for panels and modules to be designed and manufactured in a manner which minimizes any chance of liquid desiccant leaking into the air stream during use. There is a need for panels and modules that are designed to manage the air flow and desiccant flows (i.e. flow rate and pressure drop) and provide the required latent and sensible heat removal to enable the LDAC system to perform at energy efficiency levels, which make them attractive alternatives to conventional vapor compression cooling systems. There is a need to design and manufacture membrane panels and modules that can reliably withstand the thermal and mechanical stresses in the application on both the absorber (conditioner) and desorber (regenerator) sides of the system. There is a need to design and manufacture membrane panels and modules which can withstand the environmental conditions experienced in the shipping and operating environments. There is a need to design and develop modules that take into account ease of use, weight, installation, and serviceability.

In a first aspect, a heat and mass transfer panel for water vapor exchange with a liquid desiccant is provided, the panel comprising: a desiccant flow channel defined by a first flexible layer and a second flexible layer, at least one of which comprises a flexible hydrophobic water vapor-permeable separation layer; a desiccant inlet and a desiccant outlet to the desiccant flow channel; and a flexible desiccant flow distributor located in the desiccant flow channel.

In one embodiment, both the first and the second flexible layers comprise a flexible hydrophobic water-vapor permeable separation layer. In another embodiment, the first flexible layer comprises a flexible hydrophobic water-vapor permeable separation layer and the second flexible layer is a non-porous layer.

The flexible hydrophobic water-vapor permeable separation layer or layers may independently comprise a membrane, an open cell foam, a nonwoven melt blown fiber media, or combinations thereof.

In one embodiment, the flexible hydrophobic water-vapor permeable separation layer or layers independently comprise a polymeric membrane that comprises an ethylene chlorotrifluoroethylene (ECTFE) membrane, a polypropylene membrane, a polyethylene membrane, a polyvinylidene fluoride membrane, a polyethersulfone membrane, a polysulfone membrane, a polytetrafluoroethylene membrane, or combinations thereof.

The desiccant flow distributor may comprise a hydrophilic polymeric material that comprises an extruded web material, an apertured polymeric film, an open cell foam, a porous nonwoven material, a porous woven material, or combinations thereof.

In an embodiment, the desiccant flow channel comprises one flexible hydrophobic water-vapor permeable separation layer that is folded along one edge and seals along three edges while having openings for the desiccant inlet and the desiccant outlet. In another embodiment, the desiccant flow channel comprises two flexible hydrophobic water-vapor permeable separation layers that comprise seals along a first pair of opposite edges in their entirety and seals along a second pair of opposite edges having openings for the desiccant inlet and the desiccant outlet.

The seals of the heat and mass transfer panels disclosed herein may a welded seal or an adhesive seal or combinations thereof. The welded seal may comprise an ultrasonic weld.

One embodiment provides that the non-porous layer comprises polyethylene, cast, polypropylene, oriented polypropylene, PET (polyethylene terephtalate), bi-axially oriented PET, bi-axially oriented PET with aluminum or gold vapor deposited on the surface, PA (polyamide), PVC (polyvinylchloride), EVOH (ethylene vinyl alcohol) and/or co-extruded/multilayer film constructions thereof.

The heat and mass transfer panel may further comprise a porous flexible protection layer on the outside of the flexible hydrophobic water-vapor permeable separation layer, in the desiccant flow channel, or both. In one embodiment, the porous flexible protection layer comprises a polypropylene nonwoven material, a polyester nonwoven material, a polyethylene nonwoven material, an extruded web material, or an apertured polymeric film.

The heat and mass transfer panels disclosed herein may further comprise an air channel layer.

In one embodiment, the heat and mass transfer panel is effective to transfer water vapor from the air to a desiccant flowing through the desiccant channel upon contact with air having a water vapor pressure higher than the equilibrium vapor pressure of the desiccant. Other embodiments provide that the heat and mass transfer panel is effective to transfer water vapor from the desiccant to the air upon contact with air having a water vapor pressure lower than the equilibrium vapor pressure of the desiccant.

Other aspects provide a heat and mass transfer module comprising: one or more panels disclosed herein assembled among one or more air channel layers or air gaps; and an air inlet and an air outlet. The heat and mass transfer modules may further comprise two end plates between which the one or more panels and the one or more air channel layers are assembled. In a detailed embodiment, the end plates are mechanically fastened together. In some embodiments, there are an equal number of desiccant inlets and outlets. In other embodiments, there are fewer desiccant inlets than desiccant outlets. Yet other embodiments provide that there are fewer desiccant outlets than desiccant inlets.

Another aspect provides a method for water vapor exchange between air and a liquid desiccant, the method comprising: contacting any the panel disclosed herein with air having a water vapor pressure different from the equilibrium vapor pressure in a desiccant flowing through the desiccant flow channel; wherein the humidity of the air after contact with the panel is different from the humidity before contact with the panel.

In one embodiment, the water vapor pressure of the air is higher than the equilibrium vapor pressure of the desiccant, and the method further comprises transferring the water vapor from the air to the desiccant, and the humidity of the air after contact with the panel is less than the humidity before contact with the panel. In another embodiment, the equilibrium vapor pressure of the desiccant is higher than the water vapor pressure of the air, the method further comprises transferring the water vapor from the desiccant to the air, and the humidity of the air after contact with the panel is more than the humidity before contact with the panel.

Another aspect is a method of making a heat and mass transfer panel, the method comprising: forming a desiccant flow channel defined by a first flexible layer and a second flexible layer, at least one of which comprises a flexible hydrophobic water vapor-permeable separation layer; locating a flexible desiccant flow distributor in the desiccant flow channel; sealing together the first flexible layer, the second flexible layer, and the flexible desiccant flow distributor; and providing or forming a desiccant inlet and a desiccant outlet to the desiccant flow channel.

These and other aspects of the invention are described in the detailed description below. In no event should the above summary be construed as a limitation on the claimed subject matter.

### BRIEF DESCRIPTION OF THE DRAWINGS

The accompanying drawings are included to provide a further understanding of the invention described herein and are incorporated in and constitute a part of this specification. The drawings illustrate exemplary embodiments. Certain features may be better understood by reference to the following detailed description when considered in connection with the accompanying drawings, in which like reference numerals designate like parts throughout the figures thereof, and wherein:

FIG. 1 is a schematic of an embodiment of a flexible liquid desiccant heat and mass transfer panel;

FIG. 2 is a schematic of another embodiment of a flexible liquid desiccant heat and mass transfer panel with a flexible fluid manifold attached;

FIG. 3 is a schematic of another embodiment with a flexible liquid desiccant heat and mass transfer panel with a tubing manifold attached;

FIG. 4 is a schematic of another embodiment of a flexible liquid desiccant heat and mass transfer panel welded in a manner to provide serpentine flow channels;

FIG. 5 is a schematic of an end partial view another embodiment of a flexible liquid desiccant heat and mass transfer panel with a “boat” assembly attached;

FIG. 6 is a schematic of another embodiment of a flexible liquid desiccant heat and mass transfer panel with boat assemblies attached on the inlets and outlets of the desiccant flow channels;

FIGS. 7A, 7B, 7C are schematics of an embodiment of a flexible liquid desiccant heat and mass transfer panel with two air channel layers in a module assembly having two end plates;

FIG. 8 is a schematic of an embodiment of a flexible liquid desiccant heat and mass transfer panel using an open cell foam as the desiccant flow distributor;

FIGS. 9-13 are schematics module assemblies showing various air and liquid desiccant flow paths; and

FIGS. 14-17 are schematics showing a typical module assembly;

FIGS. 18-19 are process diagrams for the fabrication of flexible liquid desiccant heat and mass transfer panels;

FIG. 20 is a flowchart for assembly of a heat and mass transfer module from flexible panels;

FIG. 21 is an end view schematic of an exemplary heat and mass transfer panel; and

FIG. 22 is a schematic of an exemplary test bench for use to test panels and modules for heat and mass transfer performance.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

Provided are flexible panel devices that use desiccants for heat and mass transfer processes, including but not limited to air conditioning systems, for example, liquid desiccant air conditioning (LDAC) applications wherein the liquid desiccant is contained in a panel that comprises at least one permeable hydrophobic separation layer, which allows water vapor transfer between the air and liquid desiccant and enable dehumidification and humidification of the air. The flexible panel devices can be installed on an absorber (conditioner) side or a desorber (regenerator) side or both of a LDAC system. The devices have two flexible layers, at least one of which comprises a flexible and water vapor permeable hydrophobic separation layer, that form a desiccant flow channel and a desiccant flow distributor located therein. The two flexible layers may both be permeable hydrophobic separation layers, or they may comprise one permeable hydrophobic separation layer along with a non-porous layer. Additional optional layers include a porous flexible protection layer next to the hydrophobic layer and/or an air channel layer.

The following terms shall have, for the purposes of this application, the respective meanings set forth below.

A “panel” is a fundamental structure for achieving mass and/or heat transfer. Panels may provide multiple functionalities such as water vapor separation and distribution of a desiccant. Panels may comprise two layers, at least one hydrophobic layer and another layer, to form a channel through which desiccant flows. The hydrophobic layer facilitates water vapor separation. The channel may contain a desiccant flow distributor to facilitate substantially uniform flow through the channel.

A “module” is an assembly of several panels to achieve mass and/or heat transfer in practical commercial quantities.

“Flexible layers” and “flexible panels” refer to structures that are non-rigid and can be rolled onto itself and unrolled without damage. In one or more embodiments, such layers or panels may be rolled 180 degrees around a radius that is less than or equal to five (or two and one-half, or even less than or equal to one) times the thickness of the layer without damage.

“Hydrophobic water vapor-permeable separation layer” and “hydrophobic separation layer” refer to a structure that is porous to water vapor but is not wettable by the liquid desiccant solutions. Exemplary such structures include but are not limited to: a membrane, an open cell foam, a nonwoven melt blown fiber media, or combinations thereof.

A “liquid desiccant” is a hygroscopic material which has the ability to absorb water vapor into solution based on partial pressure differences. Examples of suitable desiccants are halide salts (such as lithium chloride, calcium chloride, and mixtures thereof, and lithium bromide) and glycols (such as triethylene and propylene glycol).

### Materials

Hydrophobic Water Vapor-Permeable Separation Layers

Hydrophobic water vapor-permeable separation layers (or hydrophobic separation layers, for short) may comprise a membrane, an open cell foam, a nonwoven melt blown fiber media, or combinations thereof. Membranes may include, but are not limited to: a polymeric membrane that comprises an ethylene chlorotrifluoroethylene (ECTFE) membrane, a polypropylene membrane, a polyethylene membrane, a polyvinylidene fluoride membrane, a polyethersulfone membrane, a polysulfone membrane, a polytetrafluoroethylene membrane, or combinations thereof. An exemplary ethylene chlorotrifluoroethylene (ECTFE) membrane is approximately 2.0 mils thick with a minimum bubble point of 20 psi when tested with a 60/40 solution of isopropyl alcohol/water. U.S. Patent Appln. Pub. No. 2011/0244013 entitled “Microporous material from ethylene-chlorotrifluoroethylene copolymer and method for making same,” commonly-assigned, discloses an exemplary ECTFE membrane and is incorporated herein by reference. In addition, any hydrophobic microfiltration or ultrafiltration membrane can be considered in the design of the panel provided it has high porosity (typically greater than 50%), good water vapor transmission performance, a water intrusion pressure high enough to prevent desiccant penetration (wetting) of the membrane during use in the application (typically greater than 10 psi), and good mechanical handling properties (i.e tensile strength, tear strength, puncture resistance, weldability, etc.). Exemplary polypropylene (PP) membranes are 3M's F100 microporous polypropylene membrane (0.20 micron) and 3M's F101 microporous prolypropylene membrane 90.45 micron). Other hydrophobic membranes which can be considered for use include but are not limited to polyvinylidene fluoride (PVDF) membranes, polysulfone (PS) or polyethersulfone (PES) membranes, polytetrafluoroethylene (PTFE) membranes, and polyethylene (PE) membranes. In addition, surface-treated hydrophilic membranes that are rendered hydrophobic are also suitable. Membranes can also be laminated to nonwoven supports, for example through point bonding operations, to provide additional mechanical support to the membrane. Other permeable hydrophobic separation layers that may be considered include a hydrophobic open cell foam or a hydrophobic nonwoven melt blown media.

Desiccant Flow Distributors

A desiccant flow distributor may include, but is not limited to a hydrophilic polymeric material that comprises an extruded web material, an apertured polymeric film, an open cell foam, a porous nonwoven material, a woven material, or combinations thereof. An exemplary aperture polymeric film is 10 mil polypropylene Delnet, which is useful in creating longitudinal desiccant flow channels between hydrophobic membrane layers. An exemplary extruded web is 30 mil polypropylene Naltex (nettings), where the structure of this material assists in spreading and mixing the desiccant in the cross channel direction to insure uniform distribution of the desiccant. Uniform desiccant flow down a channel facilitates achieving the best vapor transmission performance in the LDAC membrane module and thus the best latent heat transfer performance.

Regarding open cell foams, this type of material can distribute the liquid desiccant uniformly against the back side of the hydrophobic membrane. It can be purchased in a wide range of materials, pore sizes, and porosities. An example material which may be particularly useful is a polyester open cell foam with 20 pores per inch (PPI) produced by UFP Technologies of Georgetown, Mass. This type of material has a void volume of about 97% and has a very low pressure drop so the liquid desiccant can be pumped longitudinally down a flexible LDAC membrane panel and distributed by the foam. In addition the foam is resilient and a slight amount of compression can be applied to the flexible LDAC membrane panel when it is stacked in combination with air channel spacers. This feature allows the panels to be effectively installed in a holder while still allowing movement of the stack during operation. The full stack will experience both mechanical (due to fluid pressures) and thermal stresses (due to temperature changes) in the LDAC applications. The resiliency of the panel will allow some movement in the stack which protects the membrane from stresses which could damage the membrane and cause liquid desiccant leakage. Open cell foams which are hydrophilic may also be advantageous because this will allow the liquid desiccant to spread more effectively in the channel.

A suitable porous nonwoven material may be a polypropylene nonwoven material, a polyester nonwoven material, and/or a polyethylene nonwoven material. An exemplary nonwoven material is polypropylene Typar. This type of material may assist in breaking up fluid boundary layers on both the air and desiccant flow side of the hydrophobic membranes. Some turbulence and mixing at the surface of the membranes may enhance vapor transmission through the membrane. This material may also provide thermoplastic material which assists in a making a good thermal weld.

Protection Layers

The porous flexible protection layer may include, but is not limited to a polypropylene nonwoven material, a polyester nonwoven material, a polyethylene nonwoven material, an extruded web material, or an apertured polymeric film. Protection layers can be on the exterior side of the hydrophobic separation layers or on the interior side of the hydrophobic separation layers and adjacent to the desiccant flow distributor. An exemplary nonwoven material is polypropylene Typar, which may also be suitable for inclusion in the desiccant flow channel as a flow distributor. This material may serve as a protection layer for the hydrophobic membranes, and as discussed above, it may also provide thermoplastic material which assists in a making a good thermal weld. This type of open nonwoven material can protect the membrane from physical and environmental damage and contaminations.

Typar and Reemay materials from Fiberweb PLC are reference nonwoven materials available with a wide range of properties which may be useful in the construction of a flexible LDAC membrane panel.

Air Channel or Turbulation Layers

An exemplary air channel layer may comprise a polypropylene rail film with adhesive (structured film) as disclosed in U.S. Pat. No. 6,986,428 to common assignee 3M Innovative Properties Company and hereby incorporated by reference. This film may be useful to make an air side separator and can be designed to provide air channels with low pressure drop and also face support for the flexible LDAC membrane panel when assembled into a module. This film can also be made without the adhesive. In other words, the full geometry of the film can be made of one material such as polypropylene or polyethylene. It is also possible to make the air channel layers out of many other plastics or metals in the form of plates. The air channel layers or plates can be flexible or rigid. The plates can be machined, thermoformed, extruded, cast, or produced in a number of other ways. Rail type films may be modified with surface features to produce mixing of any fluid (i.e. air, liquid desiccant) which flows down the channels of the film. An exemplary layer may comprise a polymer film comprising micromixing surface features such as those disclosed in commonly-assigned U.S. Ser. No. 61/736,729 filed Dec. 13, 2012, entitled “Constructions for Fluid Membrane Separation Devices” and incorporated herein by reference.

Assembly of Panels

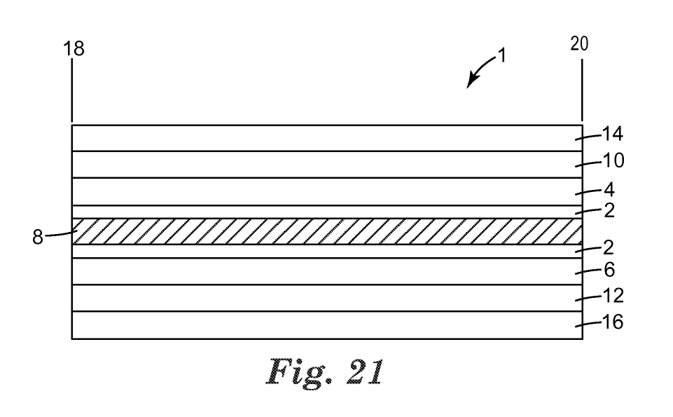

In general terms, the various layers are arranged in a desired order and affixed to each other to ensure they are leak-proof. An end view schematic of an exemplary heat and mass transfer panel is provided in FIG. 21, where heat and mass transfer panel 1 comprises a desiccant flow channel 2 formed by a first flexible layer 4 and a second flexible layer 6 and containing a flexible desiccant flow distributor 8. For illustration purposes only to show the channel, a gap between the flexible layers 4 and 6 and the flexible desiccant flow distributor 8, but in one or more embodiments, the flexible desiccant flow distributor 8 is in direct contact with flexible layers 4 and 6. The flexible desiccant flow distributor may be a combination of more than one material. Optional protection layers 10 and 12 are shown adjacent to the flexible layers 4 and 6, respectively. If both flexible layers are hydrophobic water-vapor permeable separation layers, then one or more embodiments provide that both protection layers 10 and 12 would be provided. If one of the flexible layers is a non-porous layer, then a protection layer may not be needed. Optional air channel layers 14 and 16 are shown adjacent to the protection layers 10 and 12, respectively. Seals 18 and 20 seal the layers together such that they are leak-proof in conjunction with seals on desiccant inlet and outlet edges (not shown in the end-on view of FIG. 21).

For commercial purposes, it is desirable to arrange the layers in an efficient and orderly manner. One exemplary process for making a flexible LDAC separation panel is as follows: obtain the materials for the various layers in rolled or bulk form; unwind and/or feed the layers in a stacked form, weld or bond or adhere or otherwise affix the layers together; cut the layers to length; and affix at least a desiccant inlet and optionally a desiccant outlet.

Exemplary desiccant inlets/outlets are “boat fitments,” which can also be described as an end dispensing fitment, port plate, or port disc. These structures are commonly used to attach connectors in liquid carrying bags or pouches, for example beverage pouches (e.g., wine-in-a-box pouches) and in bioprocess disposable transfer and storage bags. The boat fitments provide an opening and a body that may be welded or otherwise affixed to one end of the stacked layers. Specifically, boat fitments are typically flattened elliptical shaped pieces or wedge shaped pieces that can be inserted between two film layers. They are commonly an injected molded component. Film layers are attached to, for example, a side wall of the boat fitment typically by thermal welding, ultrasonic welding, or radio frequency welding. Adhesives can also be used to attach the boat fitments. The attached boat fitment provides for a liquid flow channel between the sealed film layers.

For the desiccant outlet, if a boat fitment is not chosen, the outlet may result from the other end of the stacked layers being unsealed or partially sealed while providing an opening for a desiccant outlet.

One or more injection molded manifold and/or hose assemblies may be in fluid communication with the desiccant inlet and/or outlet. Panels can also be configured with an unequal number of desiccant inlets and outlets by manipulating the welding geometry and manifold designs. For some configurations, it may be desirable to use fewer desiccant inlets than desiccant outlets, and in other embodiments, it may be desirable to use fewer desiccant outlets than desiccant inlets,

With respect to affixing the layers and components of the panels, various methods such as weld or bond or adhere or otherwise affixing may be used. With respect to welding, ultrasonic, thermal, hot air, and/or induction welding may be used.

For ultrasonic welding, an ultrasonic horn set such as a Branson 921 AES welder with a 2000 t controller may be used. Typical ultrasonic welding parameters are:

Weld pressure: 20-60 psi;

Weld Time: 0.1-0.5 sec;

Weld Hold Time: 0.2-0.5 sec;

Trigger Force: typically set at 12;

Down Speed; :typically set at 30; and

Amplitude: typically set at 100%.

The ultrasonic welding parameters can be varied based on types of materials, thicknesses, weld surface area, melt properties of the materials, etc., in order to produce a mechanically robust, leak-free weld.

Hot wire thermal welding, such as impulse sealing, is another acceptable method for fabrication of flexible LDAC panels. Hot air welding, rotary hot wheel welding, and induction welding are additional techniques that could be applied in the fabrication of a flexible LDAC membrane panel.

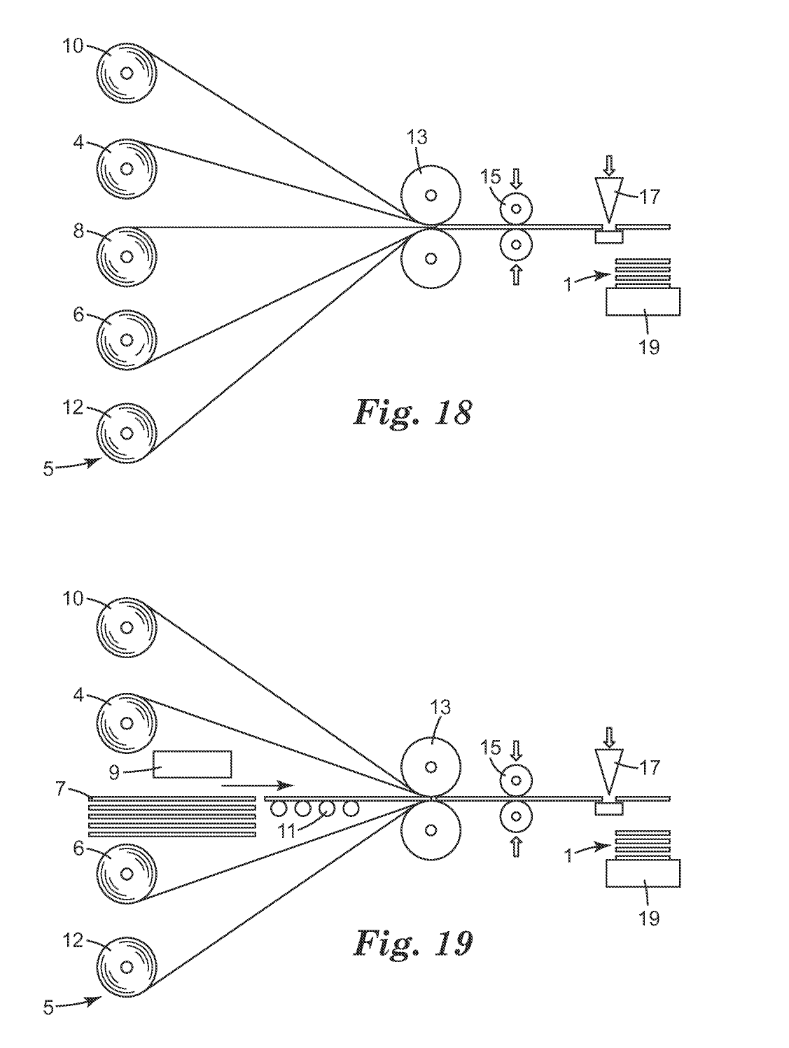

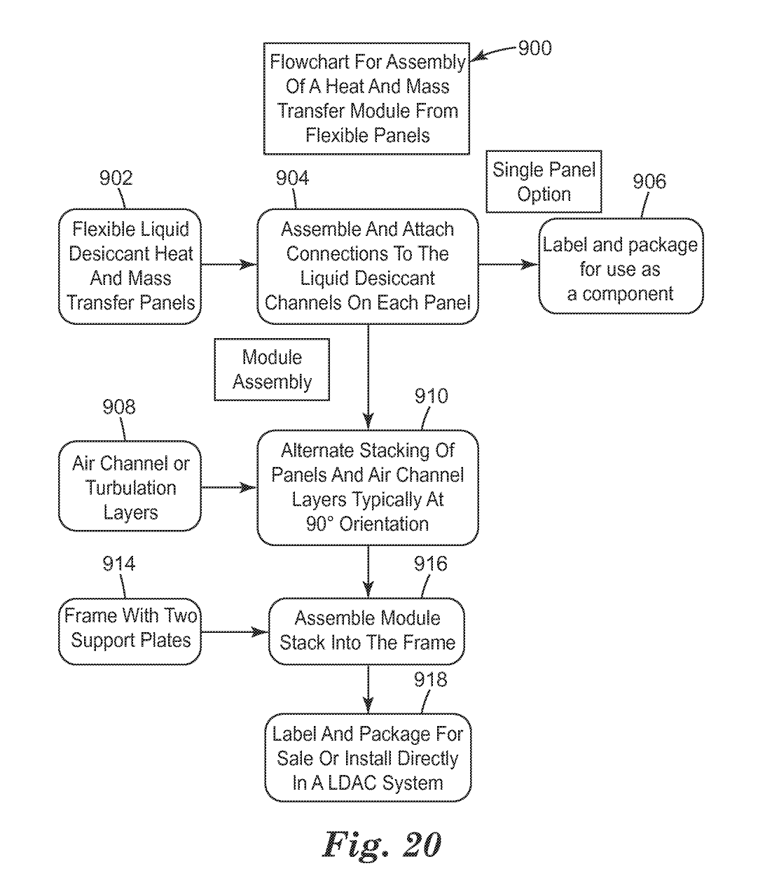

Use of adhesives and/or tapes may be desirable depending on manufacturing and application needs. FIG. 18 shows an example flexible panel fabrication system prior to attachment of fluid connections using a membrane-based desiccant flow distributor/support layer. In FIG. 18, it is shown that two flexible layers 4, 6, for example, hydrophobic separation layers, a flexible desiccant flow distributor 8, and optional protection layers 10 and 12 are unwound 5. Guide rolls 13 form a structure for receipt by a seamer 15 that provides side seams by any preferred method such as rotary ultrasonic welding, thermal welding, tape or adhesive application. A cutter 17 cuts the seamed structures to size to form heat and mass transfer panels 1, and the panels 1 are piled in a stack 19. FIG. 19 shows an example flexible panel fabrication system prior to attachment of fluid connections which incorporates an open cell foam slab feeder. In FIG. 19, it is shown that two flexible layers 4, 6, for example, hydrophobic separation layers, and optional protection layers 10 and 12 are unwound 5 and a hydrophilic open cell foam 7 is provided by a slab feeder 9 between the two flexible layers. Feed rollers 11 and guide rolls 13 form a structure for receipt by a seamer 15 that provides side seams by any preferred method such as rotary ultrasonic welding, thermal welding, tape or adhesive application. A cutter 17 cuts the seamed structures to size to form heat and mass transfer panels 1, and the panels 1 are piled in a stack 19. FIG. 20 shows a flowchart for assembly of a heat and mass transfer module from flexible panels 900 that identifies sale and/or use of individual panels with connections or sale and/or use of assembled modules. Specifically, one or more flexible liquid desiccant heat and mass transfer panels are provided 902, for example, from a process as depicted by FIG. 18 or FIG. 19. To one or more of the desiccant flow channels, fluid connections are attached and the panel or panels are assembled 904. Should a single panel be desired, then it is labeled and packaged for use as a component 906. Should a module assembly be desired, then the panels are stacked as desired 910. Air channel or turbulation layers may be added in between individual panels 908, typically at a 90° angle orientation. Alternatively, air gaps may be provided in between the individual panels. The module stack is assembled with a frame 916, comprising, for example, two support plates 914. The final module assembly is labeled and packaged for sale or installation directly into a LDAC system 918.

Assembly of Modules

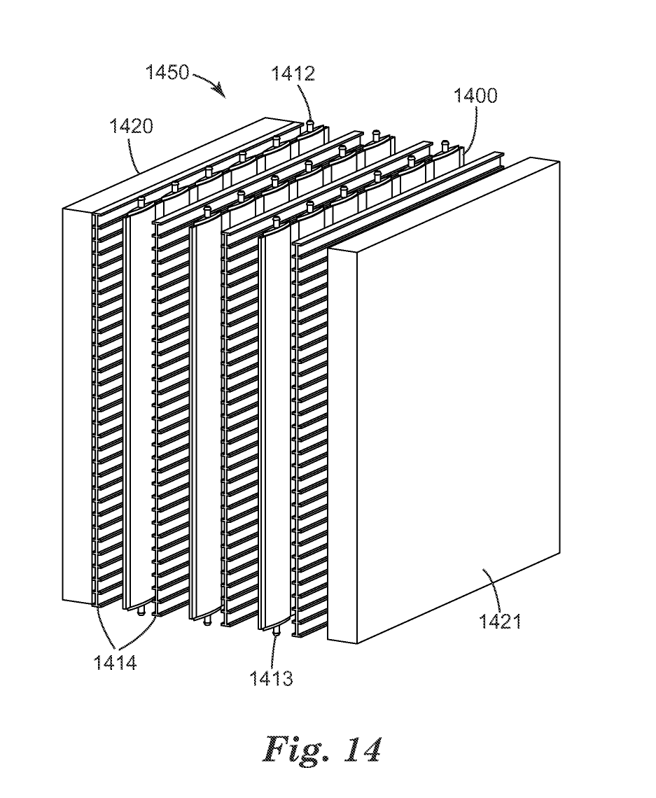

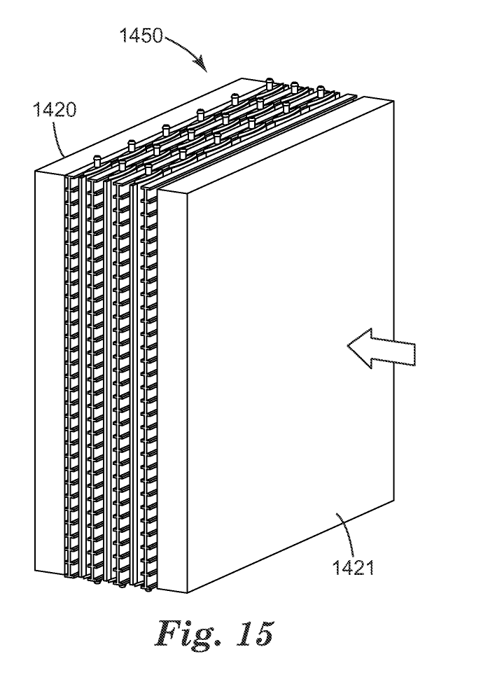

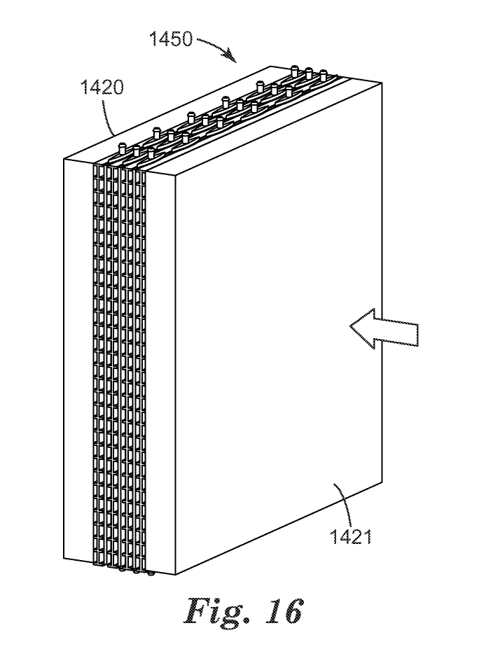

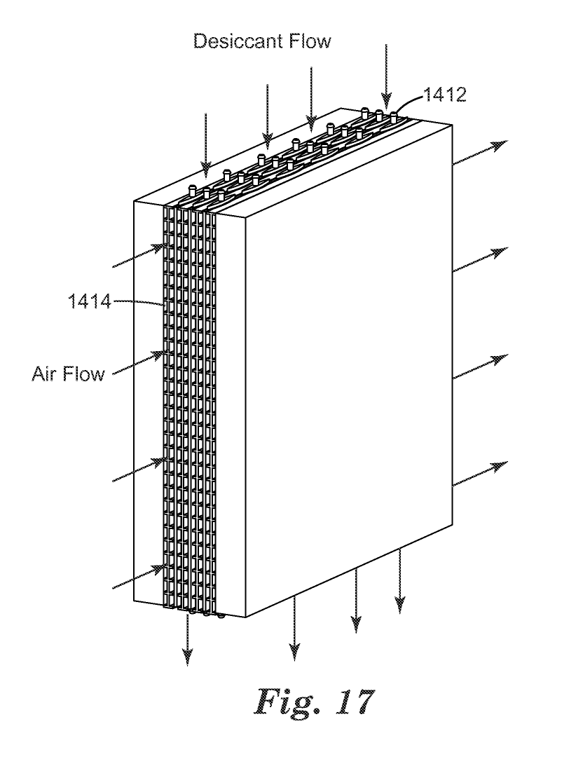

In general terms, assembly of a module involves placing one or a plurality of panels and air flow layers/plates in a standalone unit. The panel or plurality of panels may be contained within a frame, such as two plates, that allows for desiccant inflow and outflow through the desiccant channel as well as air flow along the outer surface of the panels as facilitated by an air flow layer or plate, which may be affixed to the panel or which may be provided by assembling panels such that there are air gaps between them. FIGS. 14-17 show exemplary embodiments. In FIG. 14, an expanded view of an exemplary module 1450 shows an end/fixed plate 1420 adjacent to three sets of flexible liquid desiccant heat and mass transfer panels 1400 and separated by air channel layers 1414. A desiccant inlet 1412 is shown on one end, and desiccant outlet 1413 is shown on the other end. A movable plate 1421 is used to form another end of the module and is movable to allow assembly and disassembly of the module. In FIG. 15, pre-load positioning of the components of FIG. 14 is shown. In FIG. 16, the final load positioning is shown. FIG. 17 depicts cross-flow of air through the air channel layers 1414 and desiccant into the inlet 1412, the flows being at approximately 90° angles to each other. It is noted, in addition, that air and desiccant paths can also be configured in an in-line manner with the air and liquid desiccant in concurrent or countercurrent flow.

Before describing several exemplary embodiments of the invention, it is to be understood that the invention is not limited to the details of construction or process steps set forth in the following description. The invention is capable of other embodiments and of being practiced or being carried out in various ways.

### EXAMPLES

### Example 1

A heat and mass transfer panel was made by assembling an ethylene chlorotrifluoroethylene (ECTFE) membrane as a first flexible hydrophobic water vapor-permeable separation layer adjacent to a polypropylene (PP) Typar layer, which was adjacent to a 10 mil Delnet (channels facing the first ECTFE membrane), which was adjacent to a second 10 mil Delnet, which was adjacent to a second PP Typar layer, which was adjacent to a second ECTFE membrane as a second flexible hydrophobic water vapor-permeable separation layer (the channels of the second 10 mil Delnet facing the second ECTFE membrane). The layers were welded together using ultrasonic welding to create desiccant flow channels separated and edged by welded seals.

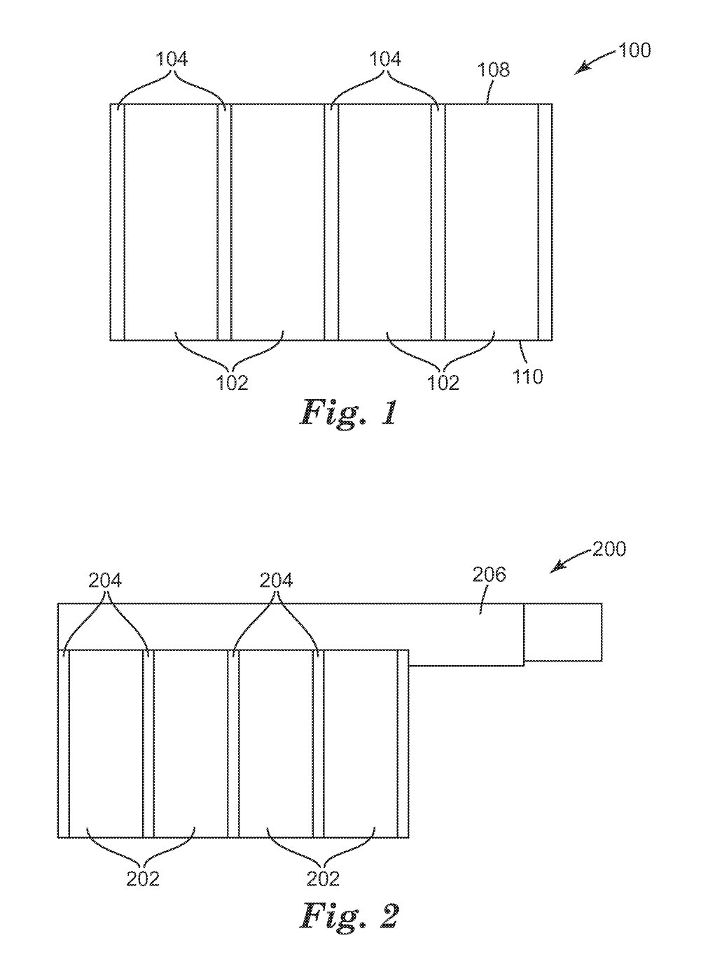

FIG. 1 shows this embodiment of a heat and mass transfer panel 100, where there are a plurality of desiccant flow channels 102 separated by and edged with seals 104 such as an ultrasonic weld. Edges 108 and 110 in their unsealed state provide a desiccant inlet and a desiccant outlet. To accommodate additional structure for containing desiccant external to the panel and to readily direct the desiccant through the flow channels, connections, ports, tubing, and/or the like may be sealed as needed to edges 108 and 110. In FIG. 2, another heat and mass transfer panel 200 is shown, where there are a plurality of desiccant flow channels 202 separated by and edged with seals 204 such as an ultrasonic weld. An optional flexible header assembly 206 may be affixed, by welding for example, to an inlet end of the panel.

### Example 2

A heat and mass transfer panel was made by assembling an ethylene chlorotrifluoroethylene (ECTFE) membrane as a first flexible hydrophobic water vapor-permeable separation layer adjacent to a polypropylene (PP) Typar layer, which was adjacent to a second PP Typar layer, which was adjacent to a second ECTFE membrane as a second flexible hydrophobic water vapor-permeable separation layer. The layers were thermally welded together using a U-Line 12″ Impulse Sealer Model H-293 to produce a sample panel having desiccant flow channels separated and edged by welded seals.

### Example 3

A heat and mass transfer panel was made by assembling an outer polypropylene (PP) Typar layer as a first protection layer adjacent to an ethylene chlorotrifluoroethylene (ECTFE) membrane as a first flexible hydrophobic water vapor-permeable separation layer, which was adjacent to a first inner polypropylene (PP) Typar layer, which was adjacent to a 10 mil Delnet (channels facing the first ECTFE membrane), which was adjacent to a second 10 mil Delnet, which was adjacent to a second inner PP Typar layer, which was adjacent to a second ECTFE membrane as a second flexible hydrophobic water vapor-permeable separation layer (the channels of the second 10 mil Delnet facing the second ECTFE membrane), which was adjacent to a second protection layer comprising PP Typar. The layers were ultrasonically welded together along their lengths and along one short side in order to form a “bag.” The edges of other short side were sealed around two flexible tubes that supplied water to the panel, which was tested for leaks using less than 5 psi water without any support for the panel. The panel was leak-free.

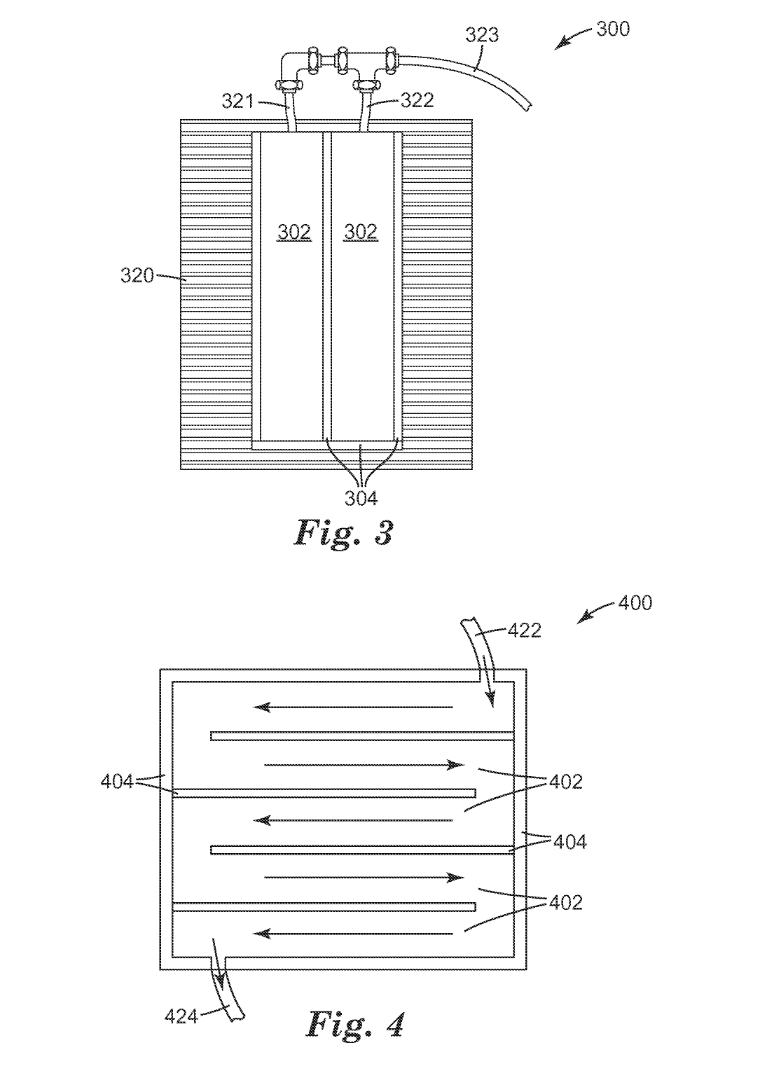

Air channel layers such as rail film air channel support material may be added on either side of the panel. This embodiment is shown in FIG. 3, where heat and mass transfer panel 300 comprises a plurality of desiccant flow channels 302 separated by and edged with seals 304 such as an ultrasonic weld and an air channel layer 320 in contact with the flexible panel 300. Such air channel layers may be affixed with, for example, adhesive in an amount that does not limit the flexibility of the panel. In this embodiment, inlets 321 and 322 are connected to tubing 323 that supplied water for testing purposes.

### Example 4

A heat and mass transfer panel was made by assembling an outer polypropylene (PP) Typar layer as a first protection layer adjacent to an ethylene chlorotrifluoroethylene (ECTFE) membrane as a first flexible hydrophobic water vapor-permeable separation layer, which was adjacent to a first inner polypropylene (PP) Typar layer, which was adjacent to a 10 mil Delnet (channels facing the first ECTFE membrane), which was adjacent to 10 mil Naltex diamond netting, which was adjacent to a second 10 mil Delnet, which was adjacent to a second inner PP Typar layer, which was adjacent to a second ECTFE membrane as a second flexible hydrophobic water vapor-permeable separation layer (the channels of the second 10 mil Delnet facing the second ECTFE membrane), which was adjacent to a second protection layer comprising PP Typar. The layers were ultrasonically welded together along the edges of two opposite lengths. The edges of the other two lengths side were sealed around two flexible tubes, such that one tube provided an inlet to the panel and the other tube provided an outlet to the panel. Internal flow channels were formed by ultrasonic welding along the length of the panel without going to the edges in order to provide fluid communication internally between the channels, resulting in a serpentine flow pattern. This panel was tested with water to demonstrate the serpentine flow pattern. In FIG. 4, heat and mass transfer panel 400 has an inlet 422 and outlet 424. The arrows in FIG. 4 show the direction of liquid flow through the flow channels 402 among the welds/seals 404 (not all welds/seals are numbered).

### Example 5

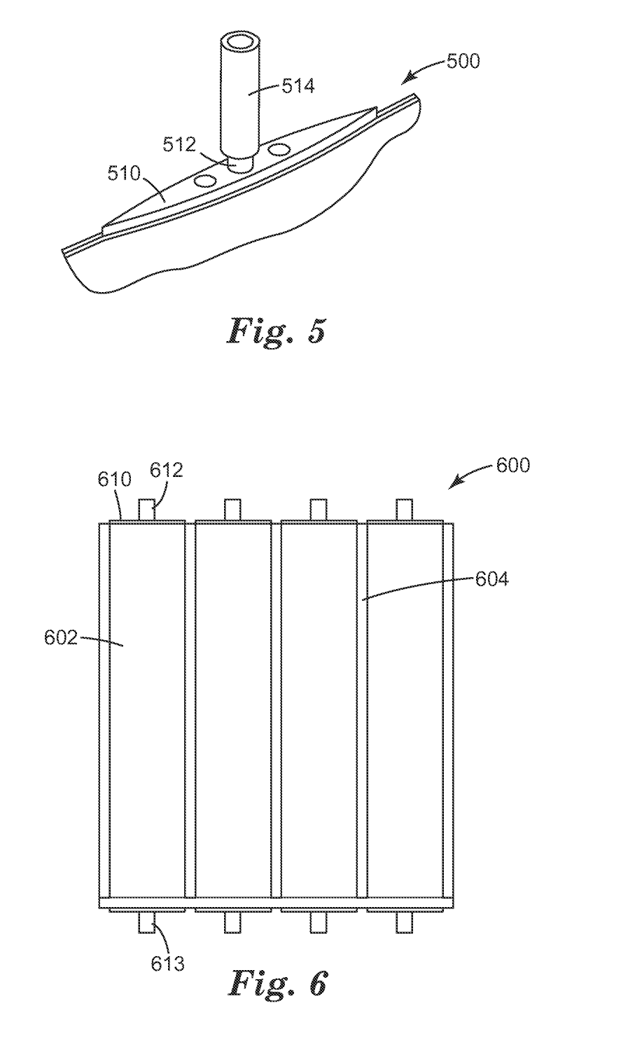

A heat and mass transfer panel was made by assembling an outer polypropylene (PP) Typar layer as a first protection layer adjacent to an ethylene chlorotrifluoroethylene (ECTFE) membrane as a first flexible hydrophobic water vapor-permeable separation layer, which was adjacent to a first inner polypropylene (PP) Typar layer, which was adjacent to a 10 mil Delnet (channels facing the first ECTFE membrane), which was adjacent to 10 mil Naltex diamond netting, which was adjacent to a second 10 mil Delnet, which was adjacent to a second inner PP Typar layer, which was adjacent to a second ECTFE membrane as a second flexible hydrophobic water vapor-permeable separation layer (the channels of the second 10 mil Delnet facing the second ECTFE membrane), which was adjacent to a second protection layer comprising PP Typar. The layers were ultrasonically welded together along the edges of two opposite lengths. To the edges of the other two lengths side were adhered two fittings called boats, such that one boat provided an inlet to the panel and the other boat provided an outlet to the panel. The boats were adhered by using a hot melt adhesive. A Luer barb fitting tubing connector was attached to each boat and tubes attached. Water was successfully pumped down the channel. In FIG. 5, a partial schematic of panel 500 is shown with boat fitment 510, the Luer barb fitting tubing connector 512, and tubing 514.

### Example 6

A heat and mass transfer panel was made by assembling an outer polypropylene (PP) Typar layer as a first protection layer adjacent to an ethylene chlorotrifluoroethylene (ECTFE) membrane as a first flexible hydrophobic water vapor-permeable separation layer, which was adjacent to a first inner polypropylene (PP) Typar layer, which was adjacent to a 10 mil Delnet (channels facing the first ECTFE membrane), which was adjacent to 7.5 mil filament-type Delnet (Kx215NAT), which was adjacent to a second 10 mil Delnet, which was adjacent to a second inner PP Typar layer, which was adjacent to a second ECTFE membrane as a second flexible hydrophobic water vapor-permeable separation layer (the channels of the second 10 mil Delnet facing the second ECTFE membrane), which was adjacent to a second protection layer comprising PP Typar. The layers were ultrasonically welded together along the edges of two opposite lengths with additional welds to form 1″ wide channels. To the edges of the opening to each channel were adhered a blue boat (representing cool liquid desiccant). To the edges of the exit of each channel were adhered a red boat (representing liquid desiccant having absorbed latent heat). Welder Settings:—50 psi air pressure, 0.3 sec weld time, 0.5 sec weld hold time, 12 trigger force, 20 down speed, 100% amplitude. In FIG. 6, this embodiment is shown, where panel 600 comprises a plurality of flow channels 602, seals 604, boat fitment 610, and Luer barb fitting tubing connectors 612 (inlet) and 613 (outlet).

### Example 7

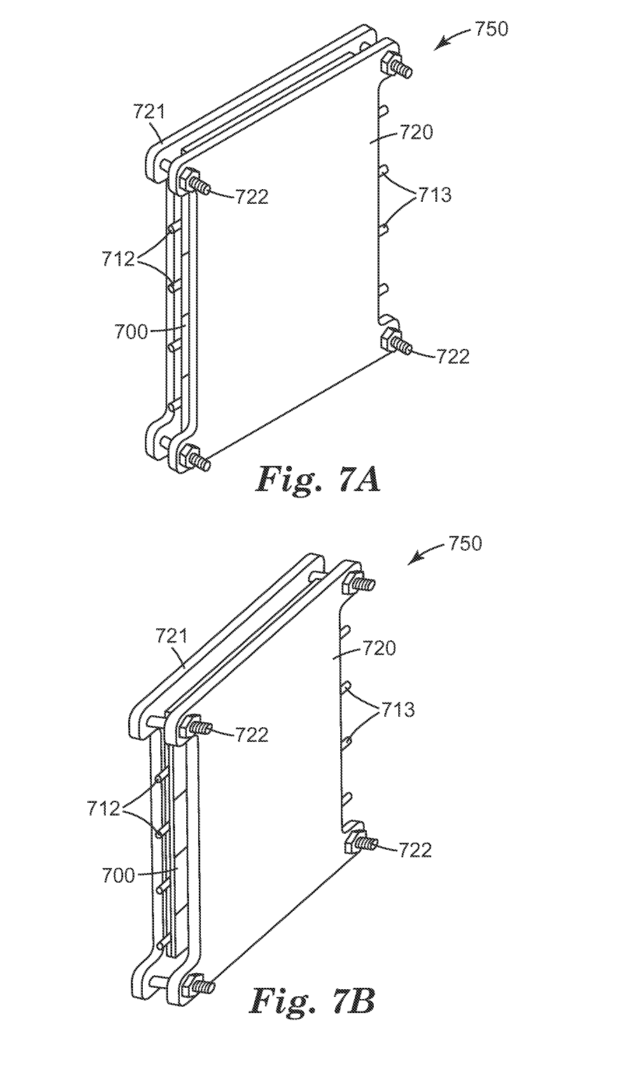

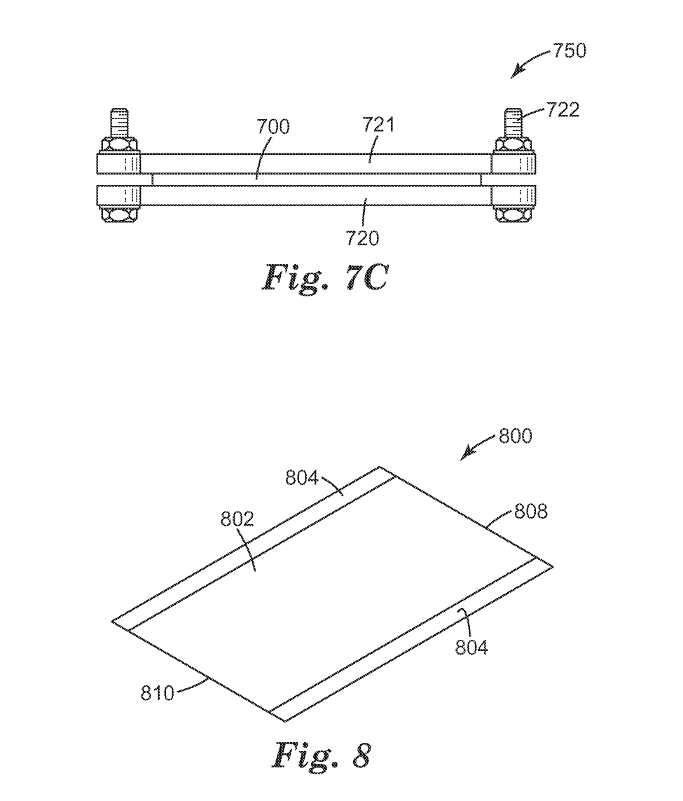

A frame was built to demonstrate an embodiment of a module or an assembled flexible LDAC panel system. Two polycarbonate end plates were connected to enable the restraint of flexible LDAC membrane panels in combination with air side channel supports. The panel from Example #6 was assembled with two air side channel supports on opposing sides of the flexible panel. The frame was adjustable so different loads could be put on the assembly. The frame could be adjusted to allow a slight gap between the assembly and the end plates, it could be adjusted to bring the end plates into contact with the assembly, or the nut and bolt tie rods could be tightened to preload the assembly. It is anticipated in use that the ability to adjust the gap and pre compression of the assembly will allow improved thermal and mechanical compliancy and thus improved reliability of the assembled module. Water was pumped with a peristaltic pump through the channels to demonstrate the flow of liquid desiccant. This embodiment demonstrates the requirements of a fully operational liquid desiccant dehumidification or humidification module (i.e. a full system) with a single flexible membrane panel. Additional panels can be stacked in combination with air channel layers/supports to increase the size and capacity of the module. In FIGS. 7A, 7B, 7C, provided are different views of an exemplary heat and mass transfer module 750 comprising two end/support plates 720, 721, plate connecting and gap adjustment features 722, one flexible LDAC panel 700 with connectors 712 (inlet) and 713 (outlet), and two air flow channel layers (not numbered).

### Example 8

A heat and mass transfer panel was made by assembling an outer polypropylene (PP) Typar layer as a first protection layer adjacent to an ethylene chlorotrifluoroethylene (ECTFE) membrane as a first flexible hydrophobic water vapor-permeable separation layer, which was adjacent to a polyurethane open cell foam (20 PPI, 0.25″ thick), which was adjacent to a second ECTFE membrane as a second flexible hydrophobic water vapor-permeable separation layer, which was adjacent to a second protection layer comprising PP Typar. The layers were ultrasonically welded together. This embodiment is shown in FIG. 8, where heat and mass transfer panel 800 has a desiccant flow channel 802, seals 804, and edges 808 and 810.

The benefit of a porous material such as an open cell foam for use in the desiccant distribution channel is based on the following principles.

The ability of a liquid to invade a textured solid depends on its intrinsic wettability with the solid and the details of the textures. This can be combined into the following equation:

$$cos θ \geq \frac{1 - {φ}_{s}}{r - {φ}_{s}}$$

where θ is the contact angle of the liquid with the solid without any textures (i.e. smooth), φₛ is the solid fraction (between 0 and 1), and r (≧1) is the ratio of true surface area of the solid to its projected area. For a porous solid, r is infinity, which implies that θ≦90°, i.e. any liquid with contact angle less than 90° will spontaneously invade a porous material. This feature of a porous material distinguishes it from solids having textures only on their surfaces where the condition for liquid invasion is more restrictive. For example, for φₛ=0.1 and r=2, 0≦62°, implying that only those liquids with contact angle less than 62° will be able to invade the solid textures.

### Example 9

A heat and mass transfer panel was made by assembling an outer polypropylene (PP) Typar layer as a first protection layer adjacent to an ethylene chlorotrifluoroethylene (ECTFE) membrane as a first flexible hydrophobic water vapor-permeable separation layer, which was adjacent to a 30 mil Polypropylene Naltex bi-planar netting, which was adjacent to a second ECTFE membrane as a second flexible hydrophobic water vapor-permeable separation layer, which was adjacent to a second protection layer comprising PP Typar. The layers were ultrasonically welded together. In addition, flow channels were created by creating seals from top edge to bottom edge at intervals along the panel.

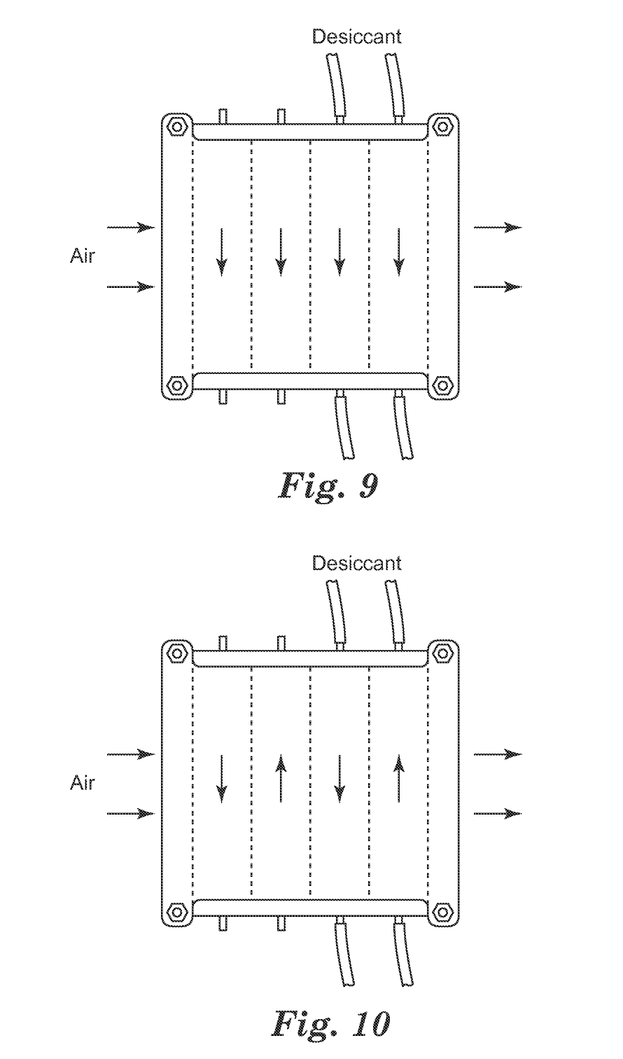

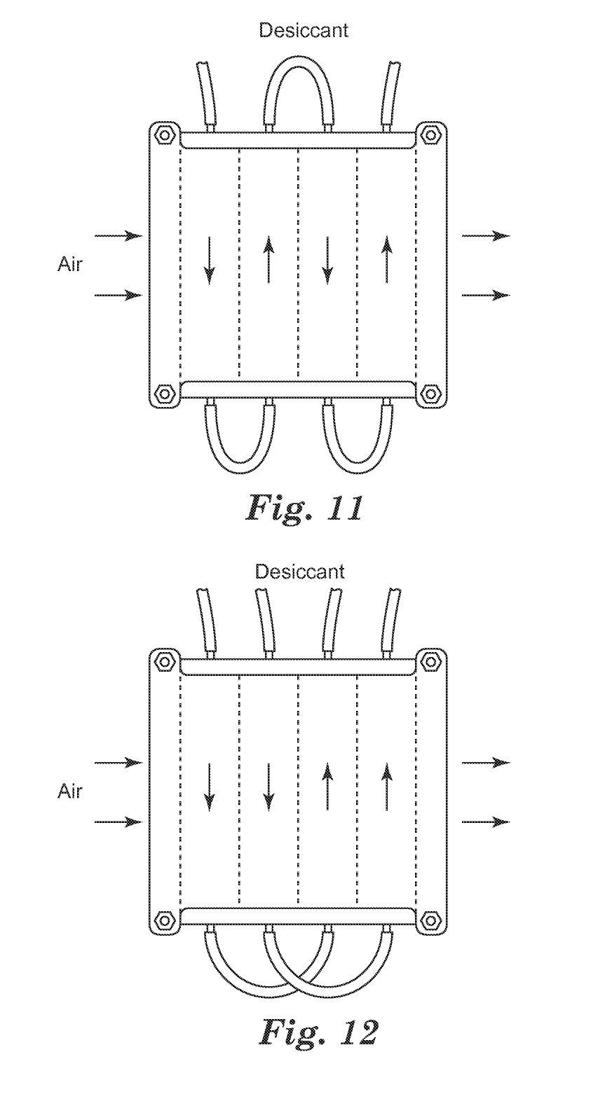

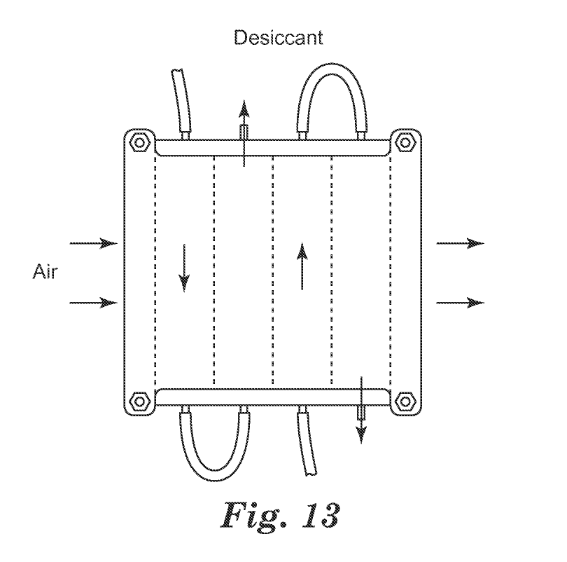

This flexible LDAC membrane panel was fabricated and luer lock fittings were hot melt adhesive attached to the top and bottom of each channel and was assembled into the frame from Example #8. Tubing external to the panels was attached to demonstrate the flexibility in the design to create various desiccant flow paths as shown in FIG. 9-13, where arrows show the liquid flow path. FIG. 9 depicts a standard 90 degree cross-flow where flow of desiccant is approximately 90° to flow of air. FIG. 10 depicts an alternating flow of desiccant through the panel, where every other channel has independent desiccant flow in one direction and the alternating channels have independent desiccant flow in the opposite direction. For both types of desiccant flow, air flow is approximately 90° to the desiccant flow. FIG. 11 depicts a serpentine flow of a single stream of desiccant through the panel, where the desiccant flows through every other channel in one direction and the alternating channels have desiccant flow in the opposite direction. FIG. 12 depicts a two path serpentine flow of a single stream of desiccant through the panel, where the desiccant flows through two channels in one direction and the alternating panels have desiccant flow in the opposite direction. FIG. 13 depicts a multi-path serpentine flow where two independent flows of desiccant are provided where flow is in one direction in a channel and in the opposite direction in the adjacent channel.

This feature of the design enables the liquid desiccant to be run in flow patterns that more closely approximate an in-line or countercurrent flow relative to the air stream. This will allow optimization of the vapor transmission and latent heat efficiency of an assembled module.

### Example 10

### Performance Testing of LDAC Panels and Modules

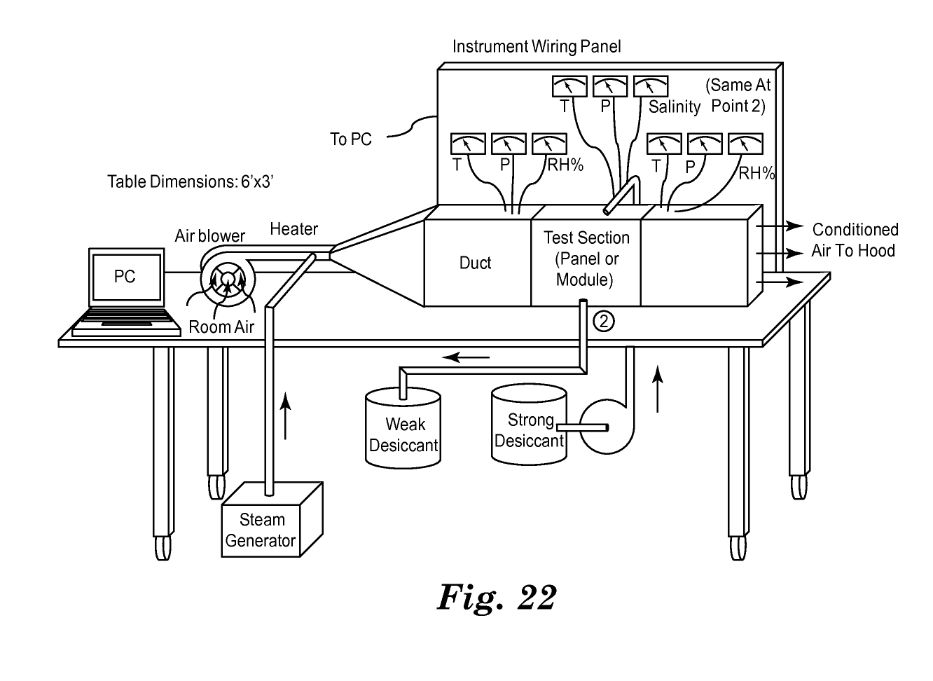

Single panels as well as modules consisting of multiple panels will be tested for heat and mass transfer performance using a test bench shown in FIG. 22. The test bench will provide air at a desired dry bulb temperature and humidity, and desiccant at a desired temperature and concentration to the inlet of the panel (or module) and will measure the same at the outlet of the panel (or module). Measurements and controls will be automated using PLC controllers and displayed on a PC for real-time analysis.

The performance will be characterized by calculating latent, εₗ and sensible, εₛ efficiencies defined as:

$$\begin{matrix}{ɛ}_{l} = \frac{{ω}_{i} - {ω}_{o}}{{ω}_{i} - {ω}_{min} ( {T}_{d , i} , {x}_{i} )} & ( 1 ) \\ {ɛ}_{s} = \frac{{T}_{db , i} - {T}_{db , o}}{{T}_{db , i} - {T}_{d , i}} & ( 2 )\end{matrix}$$

where ωᵢ and ωₒ are the humidity ratios of air at the inlet and outlet of the panel (or module), respectively, and ωₘᵢₙ(T_{d,i}, xᵢ) is the minimum possible humidity ratio of the air at the outlet corresponding to the desiccant temperature, T_{d,i} and mass fraction, xᵢ at module inlet. In Eq. (2), T_{db,i} and T_{db,o} are the air dry bulb temperatures at the inlet and outlet of the panel (or module).

In addition to the above metrics, pressure drops across the panel (or module) on the air and desiccant sides at a given flow rate are important performance criteria. The test bench allows for determination of all of these performance metrics through direct measurement.

### Example 11

Performance Testing of LDAC Panels and Modules Flexible Panels

Example flexible liquid desiccant heat and mass transfer panels were fabricated according to methods disclosed herein and then folded onto themselves without damage.

Other example flexible liquid desiccant heat and mass transfer panels were fabricated that were rolled 180 degrees around a radius of 0.50 inches without damage in both the lateral and longitudinal directions. Example flexible liquid desiccant heat and mass transfer panels were fabricated that were rolled 180 degrees around a radius of 0.25 inches without damage in both the lateral and longitudinal directions. Example flexible liquid desiccant heat and mass transfer panels were fabricated that were rolled 180 degrees around a radius of 0.125 inches without damage in both the lateral and longitudinal directions.

Example flexible liquid desiccant heat and mass transfer panels were fabricated that were rolled 180 degrees around a radius that is less than or equal to five times the thickness of the panel without damage. Example flexible liquid desiccant heat and mass transfer panels were fabricated that were rolled 180 degrees around a radius that is less than or equal to two and one half times the thickness of the panel without damage. Example flexible liquid desiccant heat and mass transfer panels were fabricated that were rolled 180 degrees around a radius that is less than or equal to one times the thickness of the panel without damage.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. A heat and mass transfer panel for water vapor exchange with a liquid desiccant, the panel comprising:
a desiccant flow channel defined by a first flexible layer and a second flexible layer, at least one of which comprises a flexible hydrophobic water vapor-permeable separation layer;
a desiccant inlet and a desiccant outlet to the desiccant flow channel; and
a flexible desiccant flow distributor located in the desiccant flow channel.

2. The heat and mass transfer panel of claim 1, wherein both the first and the second flexible layers comprise a flexible hydrophobic water-vapor permeable separation layer.

3. The heat and mass transfer panel of claim 1, wherein the first flexible layer comprises a flexible hydrophobic water-vapor permeable separation layer and the second flexible layer is a non-porous layer.

4. The heat and mass transfer panel of claim 1 further comprising a porous flexible protection layer on the outside of the flexible hydrophobic water-vapor permeable separation layer, in the desiccant flow channel, or both.

5. The heat and mass transfer panel of claim 1, wherein the flexible hydrophobic water-vapor permeable separation layer or layers independently comprise a membrane, an open cell foam, a nonwoven melt blown fiber media, or combinations thereof.

6. The heat and mass transfer panel of claim 1, wherein the flexible hydrophobic water-vapor permeable separation layer or layers independently comprise a polymeric membrane that comprises an ethylene chlorotrifluoroethylene (ECTFE) membrane, a polypropylene membrane, a polyethylene membrane, a polyvinylidene fluoride membrane, a polyethersulfone membrane, a polysulfone membrane, a polytetrafluoroethylene membrane, or combinations thereof.

7. The heat and mass transfer panel of claim 1, wherein the desiccant flow distributor comprises a hydrophilic polymeric material that comprises an extruded web material, an apertured polymeric film, an open cell foam, a porous nonwoven material, a porous woven material, or combinations thereof.

8. The heat and mass transfer panel of claim 4, wherein the porous flexible protection layer comprises a polypropylene nonwoven material, a polyester nonwoven material, a polyethylene nonwoven material, an extruded web material, or an apertured polymeric film.

9. The heat and mass transfer panel of claim 2, wherein the desiccant flow channel comprises one flexible hydrophobic water-vapor permeable separation layer that is folded along one edge and seals along three edges while having openings for the desiccant inlet and the desiccant outlet.

10. The heat and mass transfer panel of claim 2, wherein the desiccant flow channel comprises two flexible hydrophobic water-vapor permeable separation layers that comprise seals along a first pair of opposite edges in their entirety and seals along a second pair of opposite edges having openings for the desiccant inlet and the desiccant outlet.

11. The heat and mass transfer panel of claim 9, wherein the seals comprise a welded seal or an adhesive seal or combinations thereof.

12. The heat and mass transfer panel of claim 11, wherein the welded seal comprises an ultrasonic weld.

13. The heat and mass transfer panel of claim 3, wherein the non-porous layer comprises polyethylene, cast, polypropylene, oriented polypropylene, PET (polyethylene terephtalate), bi-axially oriented PET, bi-axially oriented PET with aluminum or gold vapor deposited on the surface, PA (polyamide), PVC (polyvinylchloride), EVOH (ethylene vinyl alcohol) and/or co-extruded/multilayer film constructions thereof.

14. The heat and mass transfer panel of claim 1 further comprising an air channel layer.

15. The heat and mass transfer panel of claim 1 that upon contact with air having a water vapor pressure higher than the equilibrium vapor pressure of the desiccant, is effective to transfer water vapor from the air to a desiccant flowing through the desiccant channel.

16. The heat and mass transfer panel of claim 1 that upon contact with air having a water vapor pressure lower than the equilibrium vapor pressure of the desiccant is effective to transfer water vapor from the desiccant to the air.

17. A heat and mass transfer module comprising:
one or more panels of claim 1 assembled among one or more air channel layers or air gaps; and
an air inlet and an air outlet.

18. The heat and mass transfer module of claim 17 further comprising two end plates between which the one or more panels and the one or more air channel layers are assembled.

19. The heat and mass transfer module of claim 18, wherein the end plates are mechanically fastened together.

20. The heat and mass transfer module of claim 17, wherein there are fewer desiccant inlets than desiccant outlets.

21. The heat and mass transfer module of claim 17, wherein there are fewer desiccant outlets than desiccant inlets.

22. A method for water vapor exchange between air and a liquid desiccant, the method comprising:
contacting the panel of claim 1 with air having a water vapor pressure different from the equilibrium vapor pressure in a desiccant flowing through the desiccant flow channel;
wherein the humidity of the air after contact with the panel is different from the humidity before contact with the panel.

23. The method for water vapor exchange of claim 22, wherein the water vapor pressure of the air is higher than the equilibrium vapor pressure of the desiccant, the method further comprising transferring the water vapor from the air to the desiccant, and the humidity of the air after contact with the panel is less than the humidity before contact with the panel.

24. The method for water vapor exchange of claim 22, wherein the equilibrium vapor pressure of the desiccant is higher than the water vapor pressure of the air, the method further comprising transferring the water vapor from the desiccant to the air, and the humidity of the air after contact with the panel is more than the humidity before contact with the panel.

25. A method of making a heat and mass transfer panel, the method comprising:
forming a desiccant flow channel defined by a first flexible layer and a second flexible layer, at least one of which comprises a flexible hydrophobic water vapor-permeable separation layer;
locating a flexible desiccant flow distributor in the desiccant flow channel;
sealing together the first flexible layer, the second flexible layer, and the flexible desiccant flow distributor; and
providing or forming a desiccant inlet and a desiccant outlet to the desiccant flow channel.
